(19) United States
(12) Patent Application Publication
(10) Pub. No.: US 2019/0002806 A1
(43) Pub. Date: Jan. 3, 2019

(54) CLEANING TABLET FOR DECANTERS

(71) Applicant: CLARO Products GmbH, Mondsee (AT)

(72) Inventor: Josef LUKASSER, Salzburg (AT)

(73) Assignee: CLARO Products GmbH, Mondsee (AT)

(21) Appl. No.: 15/742,950

(22) PCT Filed: Jul. 15, 2016
(86) PCT No.: PCT/EP2016/066874

§ 371 Date: Jan. 9, 2018

(30) Foreign Application Priority Data
Jul. 16, 2015 (EP) 15176976.7

(51) Int. Cl. C11D 17/00; C11D 3/00; C11D 3/10; C11D 3/20; C11D 3/33; C11D 3/39; C11D 11/00

(52) U.S. Cl. CPC C11D 17/0091; C11D 3/0052; C11D 3/10; C11D 11/0035; C11D 3/33; C11D 3/392; C11D 3/2086

(57) ABSTRACT

The invention relates to a cleaning tablet for removing wine residues, characterised in that it comprises hydrogen carbonate, citric acid, surfactant, bleaching agent, bleach activator and complexing agent, the common mass fraction of hydrogen carbonate and citric acid in the cleaning tablet lying at 30%-70%, and the molar ratio of hydrogen carbonate to citric acid in the cleaning tablet lying between 1:1 and 4:1.

The field of the present invention is the field of cleaning agents for the inside of decanters, in particular wine decanters, for removing wine residues and lime spots.

Cleaning the inside of decanters in general and wine decanters in particular is a challenge in gastronomy and in the household, in particular depending on how convoluted the designs of these containers are (for example, due to a long narrow neck that is provided). The cleaning result achieved with traditional cleaning methods (e.g., by means of a brush) is usually unsatisfactory—at least after a reasonable expenditure of effort—and often not all areas of the inside are accessible for such cleaning methods.

Preventing lime residues (lime spots, lime haze, lime streaks) on the inside of the decanter poses a special problem because these spots are usually quite visible due to the high quality of the crystal glass, usually highly polished, of the decanters and may leave an unattractive impression. The residues of wine, especially red wine, which are also readily visible are usually difficult to remove.

Furthermore, it should be noted that traditional cleaning methods (for example, by means of a brush) are abrasive and cause a clouding of the decanter after repeated use over a long period of time, but this can also make an unattractive impression. For reasons of hygiene as well as taste, especially in gastronomy, a thorough cleaning that can be achieved with a reasonable expenditure of effort may be indispensable.

Various methods and products, which are concerned with the problems described in the introduction, are known in the prior art.

Thus, for example, “cleaning beads” (e.g., made of metal) for decanters, in particular for wine decanters, are distributed. These beads are supposed to remove impurities from the inside of the decanter by mechanical action during agitation of the decanter. Cleaning may not be successful and narrow places are not accessible to the cleaning beads because of their size, and the inside of the decanter may become scratched with repeated use over a longer period of time. Furthermore, the handling of the cleaning beads tends to be complicated.

Some comparatively complicated devices are also known for cleaning decanters:

EP 1 891 871 A2 relates to a device for polishing or cleaning or drying an interior of a vessel used to hold liquids. A decanter is mentioned as a possible container in paragraph [0001] of this document.

US 2014/0283877 A1 also discloses a device for cleaning containers, in particular wine decanters (cf. paragraph [0024] of this document).

The variety of household devices, discussions, suggestions and the like on the Internet suggests that the state of the art has not yet solved the problem of cleaning the interior of decanters to the satisfaction of the household and/or gastronomy.

Thus one object of the present invention is to make available a product and/or a method that is simple to handle for cleaning the inside of decanters, in particular wine decanters. In particular, the removal of wine residues and/or lime residues should be made easier. Furthermore, the formation of lime residues should be prevented by the cleaning itself, if at all possible. Ultimately, the creation of scratches, turbidity and/or discoloration on the inside should be suppressed and/or prevented through repeated use of the present invention over a long period of time in comparison with methods and/or products for cleaning that are known in the prior art.

Therefore, the present invention makes available a cleaning tablet. The cleaning tablet according to the present invention contains bicarbonate, citric acid, surfactant, bleaching agent, bleach activator and chelating agent. The combined mass fraction of bicarbonate and citric acid in the cleaning tablet according to the invention is 30% to 70%, and the molar ratio of bicarbonate to citric acid is between 1:1 and 4:1. It is obvious for those skilled in the art that the chelating agent mentioned above is not said citric acid, but instead is another or an additional chelating agent, for example, methylglycinediacetic acid (MGDA) (although said citric acid can also be understood to be a “chelating agent”).

It has surprisingly been found that with the cleaning tablet according to the invention, a stronger mechanical action on the inside of the decanter (for example, by brushing) is not necessary for satisfactory cleaning (e.g., to remove lime residues or red wine residues)—in contrast with products and methods in the state of the art. The state of the art is not familiar with such cleaning tablets for decanters, probably because it has been assumed in the past that in any case a stronger mechanical action on the inside (e.g., due to brushing or “cleaning beads”) is not necessary for satisfactory cleaning. Among other things, the large mass fraction of bicarbonate and citric acid in the cleaning tablet according to the invention (e.g., in comparison with “dishwasher tabs”) in the molar ratio according to the invention in dissolving the cleaning tablet causes the development of gas bubbles of carbon dioxide. As a rule, the ascent of these gas bubbles (“fizzing”) in the decanter usually constitutes a sufficient mechanical action for satisfactory cleaning, to release residues from the inside for the purpose of satisfactory cleaning (especially residues of lime and/or wine, in particular red wine), especially in conjunction with other ingredients of the cleaning tablet according to the invention. Unlike the situation with brushes and/or “cleaning beads,” the relatively small gas bubbles may also reach regions on the inside of the decanter that are otherwise difficult to reach.

In the wake of the present invention, it has also surprisingly been found that the relatively large amount of water softener (citrate) formed subsequently in situ—due to the reaction of bicarbonate and citric acid in dissolving the tablet—has a positive influence on the removal of lime spots and/or on preventing the development of new lime spots, especially in conjunction with other components of the cleaning tablet according to the invention.

In addition, the mass fraction of bicarbonate and citric acid in the molar ratio provided, as specified in the invention, has the result that tablet disintegrants in the cleaning tablet may be omitted.

For dental prostheses, a cleaning tablet containing 10-30% by weight sodium bicarbonate and 5-20% by weight citric acid and/or citrate salts as well as other organic acids and/or the salts thereof having similar effects are known from EP 0 334 060 A2 (p. 6 of the document), but the patent does not specifically disclose a cleaning tablet containing the mass fraction of bicarbonate and citric acid, as provided according to the invention, in the molar ratio intended according to the present invention. The denture cleaning tablet disclosed in the specific embodiment in this document contains only 20% by weight sodium bicarbonate (i.e., actually only approx. 14.5% by weight bicarbonate) and 7% by weight sodium citrate (not citric acid). Furthermore, providing a flavoring agent which is typical of dental prosthesis cleaning tablets (0.5% by weight peppermint powder) in the embodiment given in the document illustrates that the dental prosthesis cleaning tablets are not suitable for use according to the present invention, because flavoring agents (even in traces) that are typical for dental prosthesis cleaning tablets in particular would interfere with the taste perception in drinking water or to a particular extent wine out of the decanter.

US 2014/0000658 A1 relates to a composition for cleaning and use thereof. This composition contains an oxidizing agent, sodium carbonate and/or sodium bicarbonate, a weak acid and combinations of suitable detergents. The composition according to the document does not contain any additional chelating agent such as MGDA nor does the document relate to the cleaning of the inside of decanters, in particular wine decanters which are not even mentioned in the document.

U.S. Pat. No. 6,914,368 relates to a dishwashing product in tablet form, comprising at least two layers, containing, among other things, a bleaching agent, a bleach activator and a silver/copper corrosion inhibitor. A cleaning tablet containing the mass fraction of bicarbonate and citric acid in the molar ratio provided according to the invention is not disclosed therein. Furthermore, the document does not relate to the cleaning of the inside of decanters, in particular wine decanters.

DE 199 26 376 A1 relates to effervescent tablets that are stable in storage and contain organic acids and carbonates and/or bicarbonates. A cleaning tablet with the mass fraction of bicarbonate and citric acid provided according to this patent is not disclosed in the molar ratio provided according to the invention nor does the document attempt to solve the problem of cleaning decanters, in particular wine decanters.

US 2006/0252666 A1, WO 03/089560 A2 and U.S. Pat. No. 5,384,062 relate to additional compositions for cleaning and/or additional cleaning tablets that may contain citric acid, carbonate and/or bicarbonate. These documents do not, however, anticipate or lead to the present invention.

As a rule, the cleaning tablet is used as follows: the decanter is prefilled with hot tap water and the cleaning tablet is placed in the decanter to dissolve it. The dissolved cleaning tablet is allowed to act on the inside of the decanter for 10 to 20 minutes (or even overnight), then the decanter is rinsed several times with tap water until there is no more discernible foaming. Since the lime chelating capacity of the citrate formed in situ is a function of temperature, it is advisable to avoid a water temperature of 40-50° C. at the start of the cleaning. One should usually avoid using water much hotter than this.

The combined mass fraction of bicarbonate and citric acid in the cleaning tablet according to the invention preferably amounts to at least 32%, more preferably at least 34%, even more preferably at least 36%. In addition the combined mass fraction of bicarbonate and citric acid in the cleaning tablet according to the invention is preferably at most 65%, more preferably at most 60%, even more preferably at most 55%, in particular at most 50%. The bicarbonate is preferably in the form of sodium bicarbonate or potassium bicarbonate, in particular potassium bicarbonate in the cleaning tablet according to the present invention. The citric acid is preferably present in anhydrous form in the cleaning tablet according to the invention. In addition citrate (for example, trisodium citrate as a chelating agent) and/or carbonate (for example, sodium carbonate) may also be present in the cleaning tablet.

In a preferred specific embodiment of the present invention, the molar ratio between bicarbonate and citric acid in the cleaning tablet is between 1.5:1 and 3.75:1, preferably between 2:1 and 3.5:1, more preferably between 2.5:1 and 3.25:1, even more preferably between 2.75:1 and 3.125:1, in particular essentially 3:1, because this corresponds to the stoichiometric ratio in the reaction of bicarbonate with citric acid in dissolving the cleaning tablet.

In a particularly preferred specific embodiment of the present invention, the pH is between 6.5 and 8.5, in particular between 7 and 8 or even between 7.25 and 7.75 when the cleaning tablet is dissolved in water. The pH is most especially preferably more than 6.5 and less than 7.5, preferably more than 6.6 and less than 7.4, more preferably more than 6.7 and less than 7.3, even more preferably more than 6.8 and less than 7.2, in particular more than 6.9 and less than 7.1 when the cleaning tablet is dissolved in water. To determine the pH according to the invention, the cleaning tablet (for example, having a weight of 10 grams) is placed in a volume of 100 mL, 250 mL, 500 mL or 1000 mL water. Next the pH of the solution can be measured with a commercial pH meter.

In comparison with commercial “dishwashing tabs” (pH 10-11) and/or the dental prosthesis cleaning tablet in the exemplary embodiment of the abovementioned EP 0 334 060 A2 (pH 9), for example, the pH of the cleaning tablet according to the invention tends to be in the neutral range instead of in the alkaline range after being dissolved. Under some circumstances, this reduces the cleaning effect on fat residues, which are not the customary type of soiling in decanters, but it is much gentler for the inside of the decanter in particular if it is made of glass. A strong alkaline pH promotes “glass corrosion,” so that, with repeated use of strongly alkaline cleaning tablets over a long period of time, clouding or formation of a haze or streaks in the very valuable decanter would be expected. The cleaning tablet in this embodiment according to the invention is therefore suitable for use for cleaning the inside of a decanter to a very particular extent.

Low-sudsing surfactants are especially suitable surfactants for use in the cleaning tablet according to the invention. Therefore, the surfactant in the cleaning tablet according to the invention in a preferred specific embodiment is selected from the group of low-sudsing anionic, nonionic and zwitterionic surfactants as well as mixtures of same. The anionic surfactants are preferably selected from the group of branched C₆-C₁₂ alkyl sulfates and mixtures thereof. The nonionic surfactants are preferably alkoxylated fatty alcohols, in particular ethoxylated and/or propoxylated fatty alcohols as well as mixtures thereof. The zwitterionic surfactants preferably originate from the group of C₆-C₁₂-alkylaminopropionates, C₆-C₁₂-alkylamidopropylbetaines as well as mixtures thereof. Surfactants are especially preferably selected from the group of isooctyl sulfates, isooctylsulfosuccinates, alkoxylated fatty alcohols, capryliminopropionates, caprylamidopropylbetaines and mixtures of same. The surfactants are most especially preferably selected from the group of alkoxylated fatty alcohols, preferably the ethoxylated and/or propoxylated C₆-C₁₄ fatty alcohols as well as mixtures thereof such as MARLOX® MO 154 (manufacturer: Sasol Ltd., South Africa). The mass fraction of surfactants in the cleaning tablet according to the invention is preferably 0.5% to 5%, in particular 1-3%.

Within the scope of the present invention, bleaching agent systems (i.e., bleaching agents and bleach activators) lead to especially good results when they are suitable for use at low temperatures (at a temperature up to 50° C., in particular between 40° C. and 50° C.). Therefore, in another preferred specific embodiment of the present invention, bleach activators and bleaching agents are suitable for use in the cleaning tablet at temperatures between 40° C. and 50° C. The bleaching agent system is preferably a percarbonate/tetraacetylethylenediamine (TAED) system or a percarbonate/4-decanoyloxybenzoic acid (DOPA) system or a similar system.

The chelating agent in the cleaning tablet according to the present invention is advantageously selected from ethylenediaminetriacetate (TED), ethylenediaminetetraacetate (EDTA), MGDA (preferably the trisodium salt thereof, e.g., Trilon M), glutamic acid N,N-diacetic acid (GLDA), preferably the tetrasodium salt thereof (e.g., Dissolvine® GL from Akzo Nobel, Netherlands), oxylate, maleate, tartrate, citrate (the sodium salts of the last four compounds are especially preferred) or mixtures thereof; the chelating agent is in particular selected from MGDA (and/or a salt thereof), citrate and mixtures thereof. In a preferred specific embodiment, the cleaning tablet according to the invention contains a phosphonate as an additional chelating agent. In an extremely preferred specific embodiment, the cleaning tablet according to the invention contains as a chelating agent, optionally among other things, methylglycinediacetic acid or a salt thereof and phosphonate, for example, hydroxyethylidene-1,1-diphosphonic acid.

According to another preferred embodiment of the present invention, the cleaning tablet is free of enzymes, perfumes (flavoring agents) and/or polycarboxylates. Enzymes are used in commercial cleaning agents to remove stubborn soiling (e.g., residues of noodles, eggs, milk). These are not usually necessary for cleaning decanters especially since residues of the enzymes can have a negative effect on the taste quality of a wine after such a cleaning for example. Flavoring agents can also have a negative effect on the taste quality of water or wine. Polycarboxylates (used as builders in commercial cleaning agents) can in turn form visible coatings on glass, which is also unwanted according to the invention.

The cleaning tablet according to the invention is water-soluble because at least the residues that are visible to the naked eye on the inside of the decanter are not wanted after a cleaning. In a preferred embodiment of the present invention, the cleaning tablet dissolves completely within a period of at least 10 seconds in water at a temperature of 30° C. under normal pressure, preferably at least 20 seconds, more preferably at least 30 seconds, even more preferably at least 1 minute, in particular at least 2 minutes and at most 30 minutes, preferably at most 20 minutes, more preferably at most 15 minutes, even more preferably at most 10 minutes, in particular at most 5 minutes.

In another preferred embodiment of the present invention, when the cleaning tablet is dissolved water, due to the reaction of bicarbonate with citric acid, it releases at least 0.1 g, preferably at least 0.25 g, more preferably at least 0.5 g, even more preferably at least 1 g, in particular at least 1.5 g or even at least 1.8 g carbon dioxide gas.

In another preferred embodiment of the present invention, the cleaning tablet is scored one or more times to permit a reduction in size of the cleaning tablet for use in decanters having a very narrow neck for example.

The cleaning tablet according to the invention may also comprise tableting aids and/or a disintegrant for the tablet.

If necessary those skilled in the art may provide additional ingredients for the tablet according to the invention.

In a preferred aspect, the present invention provides for the use of the cleaning tablet for cleaning the inside of a decanter, preferably made of glass, in particular made of crystal glass. The decanter is preferably a wine decanter.

In another preferred embodiment, the use according to the invention is characterized in that wine residues, in particular red wine residues and/or lime residues are removed from the inside of a decanter to a significant extent.

In another preferred embodiment, the use according to the invention is characterized in that the formation of deposits, in particular lime residues, on the inside of the decanter after its use is essentially prevented.

During use according to the invention, the decanter may also be agitated while the cleaning agent is dissolving and/or after the cleaning agent is dissolved to optionally accelerate the cleaning.

In another aspect, the present invention relates to a method comprising the following steps:

A) placing the cleaning tablet according to the invention in the decanter; and

B) introducing an aqueous liquid, in particular water, in to the decanter to dissolve the cleaning tablet; and

C) exposing the interior of the decanter to the cleaning tablet as it dissolves; and preferably

D) exposing the interior of the decanter to the cleaning tablet solution for at least 1 minute, preferably for at least 10 minutes, more preferably for at least 20 minutes, even more preferably for at least 1 hour, in particular for at least 4 hours.

For this method, the preferred embodiments are the same as those described above for the use according to the invention and vice versa.

The cleaning tablet according to the invention is particularly suitable for cleaning decanters, in particular wine decanters—preferably made of glass, in particular (high-quality) crystal glass. The cleaning tablet of the present invention is however in general also suitable for gentle cleaning (e.g., for removal of lime spots) of other containers having a narrow neck and/or a convoluted shape such as those designed for holding water in particular. These may include, among others: vases, (sports) drinking bottles, thermos flasks and CAMELBAK® drinking packs (manufacturer: Camelbak Products, LLC; USA).

The present invention is illustrated by the following example, although it is of course not limited to this example.

### EXAMPLE

The following ingredients are pressed to form a cleaning tablet weighing 10 grams:

| | Mass | |
|---|---|---|
| Name | fraction | Class |
| Calcium bicarbonate | 29.0% | Bicarbonate |
| Citric acid (anhydrous) | 20.0% | Citric acid |
| Methylglycinediacetic acid | 20.0% | Chelating agent |
| trisodium salt | | |
| Sodium percarbonate | 10.0% | Bleach agent |
| Trisodium citrate (anhydrous) | 8.0% | Citrate |
| Hydroxyethylidene-1,1- | 1.0% | Chelating agent |
| diphosphonic acid | | (phosphonate) |
| Marlox ® MO 154 | 2.0% | Surfactant |
| Polyethylene glycol 4000 | 5.0% | Tableting aid |
| Polyvinylpyrrolidone K15 | 1.0% | Tablet disintegrant |
| Tetraacetylethylenediamine | 2.0% | Bleach activator |
| (TAED) 4303 | | |
| Sodium carbonate | 2.0% | Carbonate |
| Total | 100.0% | |

The mass fraction of bicarbonate (amounting to approx. 61% of the mass fraction of potassium bicarbonate indicated above, calculated from the molar amount of bicarbonate and potassium bicarbonate) in this cleaning tablet is approx. 18%. With the citric acid contained in it this yields a combined mass fraction of bicarbonate and citric acid of approx. 38% in this cleaning tablet. When expressed in quantities of substance, this 10-gram cleaning tablet contains approx. 29 mmol bicarbonate and approx. 10 mmol citric acid. The molar ratio of bicarbonate to citric acid in this cleaning tablet is thus approx. 3:1.

A wine decanter (model Eve der Riedel Glas Austria, volume 1.4 L, item no. 1950/09) soiled with red wine residues was filled with tap water (temperature 40° C., water hardness: 15° dH [German degrees of water hardness]). Then the cleaning tablet was placed in the wine decanter and dissolved within 2.5 minutes with a great production of carbon dioxide bubbles in the tap water. After 20 minutes at room temperature, the wine decanter was emptied and rinsed three times with tap water (temperature: 40° C., water hardness: 15° dH). There were no longer any visible red wine residues or lime spots.

1. A cleaning tablet comprising bicarbonate, citric acid, a surfactant, a bleaching agent, a bleach activator and a further chelating agent,
wherein the joint mass fraction of bicarbonate and citric acid in the cleaning tablet is 30%—70%, and the molar ratio of bicarbonate to citric acid in the cleaning tablet is between 1:1 and 4:1.

2. The cleaning tablet according to claim 1, wherein the pH when the cleaning tablet is dissolved in water is between 6.5 and 8.5.

3. The cleaning tablet according to claim 1, wherein the surfactant is a low-sudsing surfactant selected from the group of anionic, nonionic and zwitterionic surfactants as well as mixtures of same.

4. The cleaning tablet according to claim 1, wherein the bleach activator and the bleaching agent are suitable for low-temperature use.

5. The cleaning tablet according to claim 1, wherein the cleaning tablet contains methylglycinediacetic acid or a salt thereof and phosphonate as the chelating agent.

6. The cleaning tablet according to claim 1, wherein the tablet is free of enzymes, polycarboxylates and/or perfumes.

7. (canceled)

8. The cleaning tablet according to claim 1, wherein the molar ratio of bicarbonate to citric acid in the cleaning tablet is between 2:1 and 3.5:1.

9. The cleaning tablet according to claim 1, wherein the molar ratio of bicarbonate to citric acid in the cleaning tablet is essentially 3:1.

10. A method for cleaning a container comprising the following steps:
dissolving the cleaning tablet of claim 1 at least partially in an aqueous liquid, whereby a cleaning tablet solution is formed; and
exposing at least a portion of the interior of a container to the cleaning tablet solution.

11. The method of claim 10, wherein the container is a decanter.

12. The method of claim 10, wherein the container is a wine decanter.

13. A method for cleaning a decanter comprising the following steps:
placing the cleaning tablet of claim 1 into the decanter;
introducing an aqueous liquid into the decanter to dissolve the cleaning tablet; and
exposing the interior of the decanter to the liquid containing the cleaning tablet as it dissolves whereby a cleaning tablet solution is formed.

14. The method of claim 10, further comprising:
exposing the interior of the decanter to the cleaning tablet solution for at least 1 minute.
